(19) United States
(12) Patent Application Publication
(10) Pub. No.: US 2020/0288554 A1
(43) Pub. Date: Sep. 10, 2020

(54) SYSTEMS AND METHODS FOR PROVIDING ILLUMINATION

(71) Applicant: Moon Selfie, Inc., Boston, MA (US)

(72) Inventors: Edward Madongorere, Boston, MA (US); Dishen Yang, Boston, MA (US)

(21) Appl. No.: 16/810,073

(22) Filed: Mar. 5, 2020

Related U.S. Application Data
(60) Provisional application No. 62/814,637, filed on Mar. 6, 2019.

(51) Int. Cl. H05B 47/105

(52) U.S. Cl. CPC H05B 47/105

(57) ABSTRACT

An illumination system is disclosed for providing illumination. The system includes at least one sensor that is not visible from outside the device, said sensor for controlling at least an aspect of the illumination.

### PRIORITY

The present application claims priority to U.S. Provisional Patent Application Ser. No. 62/814,637, filed Mar. 6, 2019, the disclosure of which is hereby incorporated by reference in its entirety.

### BACKGROUND

The invention generally relates to illumination systems, and relates in particular to illumination systems for use with easily transported objects such as mobile computing devices.

Some objects, people, and environments (people, places and things) require illumination to be seen in the dark (e.g., book, guests in a dimly lit restaurant, or the streets at night), and other objects and environments may provide their own illumination (e.g., smartphones, tablets, portable computers, ambient and indoor lighting). Even when illumination is provided, for example, for photography or videography, or for identifying people, places, and things, these situations may not have sufficient illumination for devices, for example, that are not specifically associated with image recording devices (e.g., a flash and associated camera).

There is a need therefore, for illumination systems that may be easily and readily used with devices in remote, dark, indoor, or any dimly lit environments, with or without commonly transported objects.

1175119.1

### SUMMARY

In accordance with an aspect, the invention provides a system for providing illumination that includes at least one sensor that is not visible from outside the device, said sensor for controlling at least an aspect of the illumination.

In accordance with another aspect, the invention provides a system for providing illumination of a subject from a front side of the system. The system includes a back side and at least one sensor proximate the back side for controlling the illumination from the front side.

In accordance with a further aspect, the invention provides a system for illuminating a subject. The system includes a portable computing device including any of a smartphone, a tablet, a smartwatch and a laptop, and an illumination device that is removably attached to the computing device

In accordance with yet a further aspect, the invention provides a system for illuminating a subject. The system includes a personal non-computing object including any of an article of clothing, a personal bag and an accessory, and an illumination device that is suitable for use with the personal non-computing object.

In accordance with still a further aspect, the invention provides a system for providing illumination. The system includes at least two portions separated by a flexible band, one portion including an illumination unit and the other portion including at least one control unit, wherein the flexible band includes electronic circuitry coupled to both the illumination unit and the control unit.

### BRIEF DESCRIPTION OF THE DRAWINGS

The following description may be further understood with reference to the accompanying drawings in which:

FIG. 1 shows an illustrative diagrammatic view of an electronics power system for use in devices of various aspects of the invention;

FIG. 2 shows an illustrative diagrammatic view of an electronics communication system for use in devices of various aspects of the invention;

FIG. 3 shows an illustrative diagrammatic front isometric view of an illumination system in accordance with an embodiment of the present invention;

FIG. 4 shows an illustrative diagrammatic left side view of the illumination system of FIG. 3;

FIG. 5 shows an illustrative diagrammatic left side exploded view of the illumination system of FIG. 3;

FIG. 6 shows an illustrative diagrammatic front isometric exploded view of the illumination system of FIG. 3;

FIG. 7 shows an illustrative diagrammatic front view of the illumination system of FIG. 3;

FIG. 8 shows an illustrative diagrammatic rear isometric view of the illumination device of FIG. 3;

FIG. 9 shows an illustrative diagrammatic rear isometric exploded view of the illumination device of FIG. 3;

FIG. 10 shows an illustrative diagrammatic sectional view of the illumination device shown in FIG. 7 taken along line 10-10 thereof;

FIG. 11 shows an illustrative diagrammatic rear view of the illumination device shown in FIG. 4 with the housing removed;

FIG. 12 shows an illustrative diagrammatic view of a smart phone on which an illumination system may be attached in accordance with an aspect of the invention;

FIG. 13 shows an illustrative diagrammatic view of multiple smart phones and mobile computing devices with which illumination systems may be used in accordance with an aspect of the invention;

FIG. 14 shows an illustrative diagrammatic view of a mobile computing devices with which illumination systems may be used in accordance with an aspect of the invention;

FIG. 15 shows an illustrative diagrammatic view of multiple mobile computing devices with which illumination systems may be used in accordance with an aspect of the invention;

FIG. 16 shows an illustrative diagrammatic view of a printed media device with which illumination systems may be used in accordance with an aspect of the invention;

FIG. 17 shows an illustrative diagrammatic view of a wearable article with which illumination systems may be used in accordance with another aspect of the invention; and

FIG. 18 shows an illustrative diagrammatic view of a carrying container with which illumination systems may be used in accordance with a further aspect of the invention.

The drawings are shown for illustrative purposes only.

### DETAILED DESCRIPTION

In accordance with various embodiments, the invention provides systems and methods for providing illumination (e.g., supplemental illumination) by itself or in connection with a portable object such as a smartphone or a jacket. The illumination may be controlled by one or more user interfaces (sensors, control interfaces, detection methods) that may be internal (part of) the system, but may not be visible, or be external to the system on other devices (e.g., smartphone or voice-activated smart speaker) via wireless (over the air—OTA) communication.

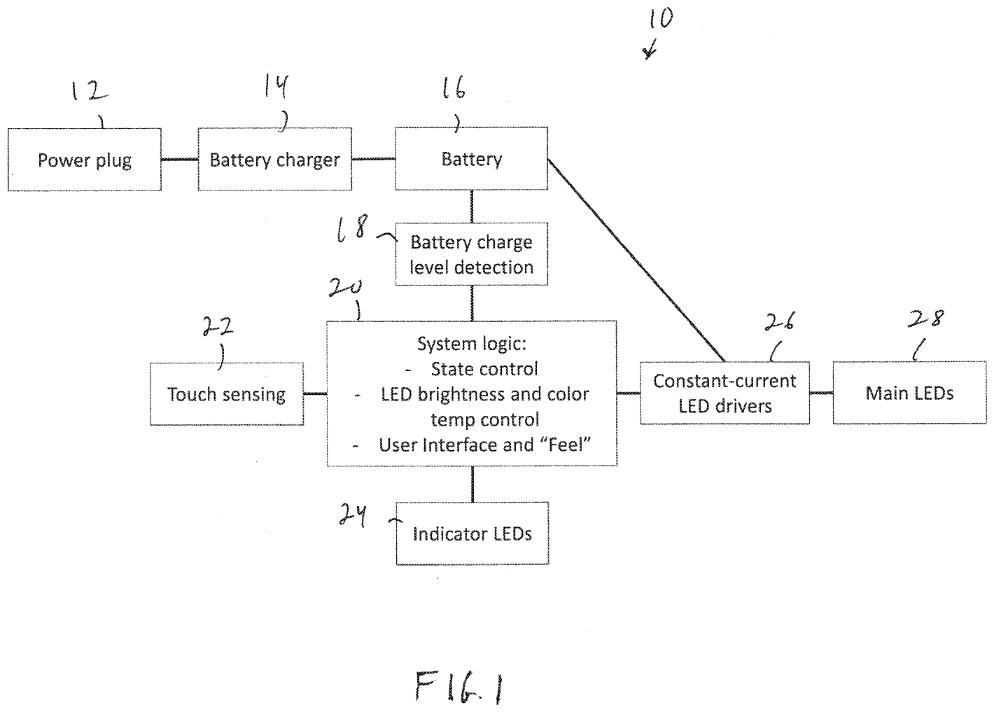

FIG. 1 shows at 10 a power control system in accordance with an aspect of the present invention that includes a power plug 12, battery charger 14 and a battery 16. The battery 16 is coupled to system logic (including state control, LED brightness, color and temperature control, and a user interface and “feel”) 20 via a battery charge level detection unit 18. The system logic 20 is coupled to a touch sensing unit 22, indicator LEDs, constant current LEDs 26 (which are also coupled to the battery 16), and to main LEDs 28.

A detailed description of features, aspects and component parts of systems in accordance with further aspects are as follows. In accordance with various aspects, the system includes an electronic systems that allow user(s) to control the output (intensity and frequency=brightness and wavelength) of LIGHT (any range of the electromagnetic spectrum—radio, microwave, infrared, visible light, ultraviolet, x-rays, gamma rays). The “lighting members” that emit light can be electronic components or devices like LEDs, incandescent lamps, florescent lamps, cold cathode florescent lamps (CCFL), etc. There can be any number of “light members”, configurations, shapes, sizes, etc. The “light members” can have illuminance of at least 1 lumen per square meter (lux)—can have at least 1 lux ranging to at least 10,000 lux, and the “light members” can have different colors. In accordance with an aspect, the system may include two or more LEDS of different color/hue and their brightness can be controlled by the user via the user interface.

The electronic systems can allow user(s) to control the output of other human—perceivable signals such as haptics (vibration, sense of touch), audio (sounds, music), etc. The haptic output can be electronic components or devices like a small motor, offset motor—Eccentric Rotating Mass (ERM), linear resonant actuator (LRA), piezoelectric actuators, forced impact (accelerated ram), etc. There can be any number of haptic components/devices, configurations, shapes, sizes, etc. When a user interacts with the interface, such as pressing a button or touching a touch sensitive pad, the processor and software algorithms (system logic) can control a piezoelectric actuator to produce a variety of haptic sensations such as a click, a buzz, etc. in accordance with various aspects. The audio output can be electronic components or devices like a horn, electrodynamic loudspeaker, flat panel speaker (planar, electrostatic, or multi-cell flat diaphragm), plasma arc speaker, piezoelectric speaker, etc. There can be any number of audio output components/devices, configurations, shapes, sizes, etc. When a user interacts with interface, such as sliding their fingers across a touch sensitive pad, the processor and software algorithms (system logic) can control a piezoelectric speaker to produce a range of sounds of varying frequencies or play a musical tune, or a beep, etc. in accordance with various aspects.

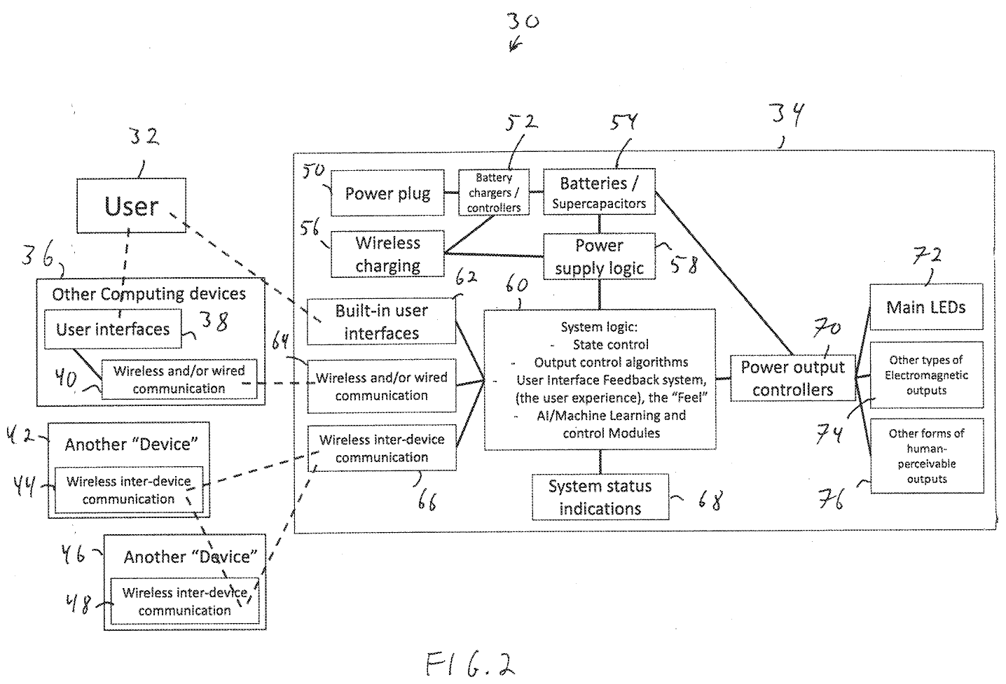

FIG. 2 shows an electronics system 30 in accordance with an aspect of the invention that includes communication system. In particular, a user 32 communicates with a device 34 as well as other computing devices 36 via user interfaces 38 and wireless or wired communication. The device 34 may also communicate with another device 42 via wireless inter-device communication 44, as well as a further device 46 via wireless inter-device communication 48.

The device 34 may, again, be powered via a power plug 50, battery chargers/controllers 52 and batteries (or supercapacitors) 54. Wireless charging 56 may also be provided as the battery chargers 52 and power is provided to power supply logic 58. The system logic 60 (including state control, output control algorithms, user interface feedback system (the user experience), and the “feel”, and AI/machine learning and control modules. The user is in communication with the system logic 60 via built-in user interfaces 62, and the other computing devices 36 communicate with the system logic 60 via wireless and/or wired communication 64. The further devices 42, 46 communicate (with each other and) with the system logic 60 via wireless inter-device communication 66. The system logic 60 provides status information via system status indications 68, and is in communication with main LEDs 72, other types of electromagnetic outputs 74 and other forms of human-perceivable outputs 76 via power output controllers 70.

The device may therefore include various inputs and output ports to allow for powering the device, connection of additional devices, communication, physical attachment, etc. These ‘wired’ or physically attached ports may include headphone and headset jacks, video ports, universal serial bus USB ports (Micro USB, USB-C, and all its different versions and types), IEEE-1394 ports, Ethernet and modem ports, AC and/or DC power connectors, Firewire, Lightning, VGA, HDMI, etc. The ‘wireless’ ports may enable communication via any types of networks and protocols such as Wireless Personal Area Networks (WPANs) such as—Bluetooth, radio, infrared and visible light, ZigBee, Wireless Local Area Network (WLAN) such as—Wi-Fi, laser, microwave, point-to-point, router, hotspot, IEEE 802.11, etc. Wireless Ad HC Network (MANET). Wireless Metropolitan Area Networks (WMAN) such as WiMAX. Wireless Wide Area Networks (WWAN). Cellular network/mobile network. Global Area Network (GAN). Space Network, etc.

During use, a user can control the light and other output components by interacting with the user interfaces. Signals from the user interfaces travel through the system logic in the electronic system then to LEDs and other output components. The user interface can be internally part of electronic system or external to the system on any number of another electronic system (such as other units of this invention, smartphones, computers, browser, servers, the “cloud”, remote control, etc.). The user interface can be any combination of sensors that communicates user intentions to the system logic in the electronic system (capacitive touch sensing, touch screen, temperature, proximity, pressure, water, chemical, gas, smoke, Infrared, level, image, motion, acceleration, gyroscope, humidity, optical, capacitance, light, sound, on-off switch/button, etc.). The system logic can control the output components without User input or any signals from the user interfaces via AI/Machine Learning/Self-generated/Self-directed software and programming embedded within the system logic or within external electronic systems (such as other units of the present invention, smartphones, computers, browsers, servers, the “cloud”, remote control, etc.).

In accordance with certain aspects, the system has two capacitive touch sensors (pads) that is part of the circuit board and electronic system which acts as the user interface. Users may touch these PADS directly, at a short distance away, and even through materials like plastic, wood, fabric, etc. The touch sensing component detects changes in capacitance levels on the pads and sends signals to the System Logic, which then controls the amount of current to be directed from the battery/power source to the each of the LEDs. In accordance with certain aspects, touching both pads at the same time turns on the device, and while device is on, touching both pads at the same time switches modes brightness and color mode. In accordance with further aspects, while device is on, touching the one pad a time either dims or brightens the LEDS simultaneously in brightness mode, or individually in color mode, and dimming the LEDS to a minimum while in brightness mode turns off the device.

With reference again to FIG. 2, each device can communicate wirelessly with any number of other devices, and each device can act as the ‘master’ (signal sender) or the ‘slave’ (signal receiver) and process the instructions accordingly. For example, the system may provide a swarm/wave effect as follows. One device may send the commands ‘vibrate and blink LEDs for 5 second and pass along this command to each nearby device that has not received this command in the past 30 seconds. In a crowd of hundreds or thousands of devices, the macroscopic/emergent effect would be akin to ripples in a pond where each device acts like a drop of water hitting the pond for 5 seconds, and for after every 30 seconds, the devices would once again be ready to become subjected to this command. In accordance with further aspects of the invention, touching either pad may trigger the piezoelectric actuator to vibrate a buzz or click sensation to the user, and or the piezoelectric speaker to vibrate a beep or melody to the user.

In accordance with certain aspects, the device may wirelessly communicate with another device like a smartphone, and on the smartphone its proximity sensor may trigger the device to adjust the brightness of its LEDs according to a custom or recommended setting as well as trigger its camera to snap a photo or record a video of the user/things. In accordance with further aspects, the device may wirelessly communicate with another device like a tablet/laptop and moving this tablet/laptop may signal the device to adjust the brightness of its LEDs according to where the user's face is detected by the tablet/laptop's camera and facial recognition software.

The device may be wired and communicating with other devices like a 3-axis gimbal and a DSLR Camera where the camera may be tracking the moving object of interest and the gimbal's accelerometer/gyro would stabilize/maintain this tracking as well as signal the device to adjust the brightness of its LEDs based on an AI/machine algorithm that determines the optimal lighting intensity, color, and angle for the desired visual effect in accordance with certain aspects. The device may be removably attached to a book, a wall, a bag, a piece of clothing, etc. and wirelessly communicating with a smart home/speaker/robot system like the Amazon Echo/Dot, Google Home, etc. with voice-controlled intelligent assistance services like Alexa, Siri, Bixby, Google Assistant, etc. and the user may issue voice commands to the smart system to auto adjust the device's lighting intensity, color, and combination based a preset user profile/setting or ambience lighting in the surrounding area.

The process for operating the device may provide the ability to turn the light sources on or off at predetermined intervals, dim/fade/blink/any combination of patterns, synchronize providing power to the light sources with taking picture or videos such that the light sources turn on when user desires to take photos or videos.

In accordance with further aspects of the invention, the electronic systems can be powered internally from a power source like battery(s) or from external sources via a wired connection or communication port or wirelessly via a receiver (induction) capturing power (electromagnetic energy) over the air from any variety of electromagnetic radiation (full spectrum). The power source (like internal batteries) can be charged from external source via wired connection or communication port or wirelessly via a receiver (induction) capturing power (electromagnetic energy) over the air from any variety of electromagnetic radiation (full spectrum). The system can have any number of power sources like batteries in any size, shape, configurations, etc. The power source can provide any range of voltages and currents such as 1V, 3V, 5V, 9V, 12V, 24V, 0.01 mA (milliamps)-1000A (amps) and can have any capacities such as 0.01 mAh (milliamp hour)-1,000,000 mAh. The power source can be any varieties such as batteries, permanent or rechargeable, solar cells, fuel cells, bio cells, etc.

The power source can provide power to the electrical systems via direct current DC or alternating current AC, and may be a rechargeable, removable replaceable or single-use battery in accordance with certain aspects of the invention. The power source may include chemistries selected from graphine, zinc carbon, zinc-chloride, alkaline, oxy nickel hydroxide, lithium (e.g., lithium-copper oxide, lithium-iron disulfide lithium-manganese dioxide), mercury oxide, zinc-air, silver oxide, nickel cadmium, lead acid, nickel metal hydride nickel zinc and lithium ion. In accordance with further aspects, the power source may include an electrochemical cell. An electrochemical cell may include a fuel cell such as, for example, a proton exchange membrane fuel cell or high temperature fuel cell (e.g., solid oxide fuel cell, molten carbonate fuel).

Additionally, the power source may include a metal hydride fuel cell, electro-galvanic fuel cell, direct formic acid fuel cell, zinc-air fuel cell, microbial fuel cell, upflow microbial fuel cell, regenerative fuel cell, direct borohydride fuel cell, alkaline fuel cell, direct methanol fuel cell, reformed methanol fuel cell, direct ethanol fuel cell, proton exchange membrane fuel cell, flow battery or redox type fuel cell, phosphoric acid fuel cell, molten carbonate fuel cell, solid oxide fuel cell (e.g., tubular solid oxide fuel cell protonic ceramic fuel cell, direct carbon fuel cell planar solid oxide fuel cell. enzymatic biofuel cell and magnesium-air fuel cell).

In accordance with certain aspects, the device may include one or more photo-voltaic solar cells or PV modules for providing energy to a battery included in the device or a portable electronic device in electrical communication with the PV cell. The PV cell or module may capture solar energy and convert the solar energy to electrical current. Electrical current may subsequently be used to power the portable electronic device or charge (or re-charge) the battery. The PV cell or module may be integrated into the device. For example, the PV cell or module may be provided on a surface of the device and in electrical communication with the battery, a connector for mating with an interface of the portable electronic device, or both. As another example, the device may be formed of a PV material, such as a flexible PV material that is molded into the shape of a sphere.

The system may also include an internal rechargeable battery (li-on, lithium ion), which is connected to and powering the electronic systems and is also connected to a Micro USB connector by which an external power source may charge the battery and/or power the device in accordance with certain aspects of the invention.

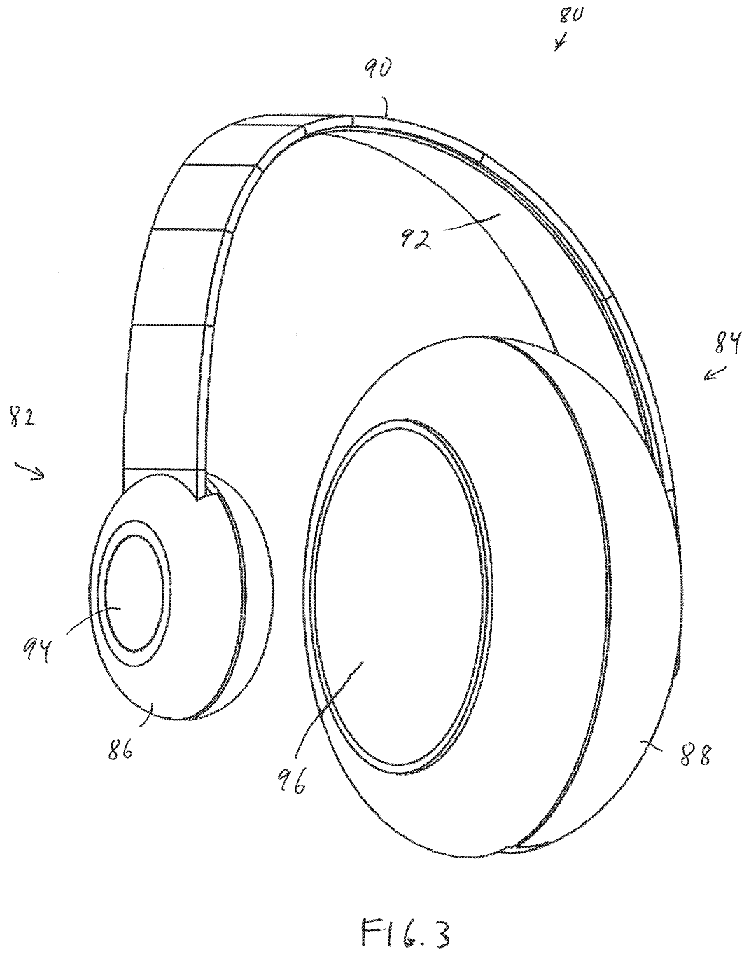

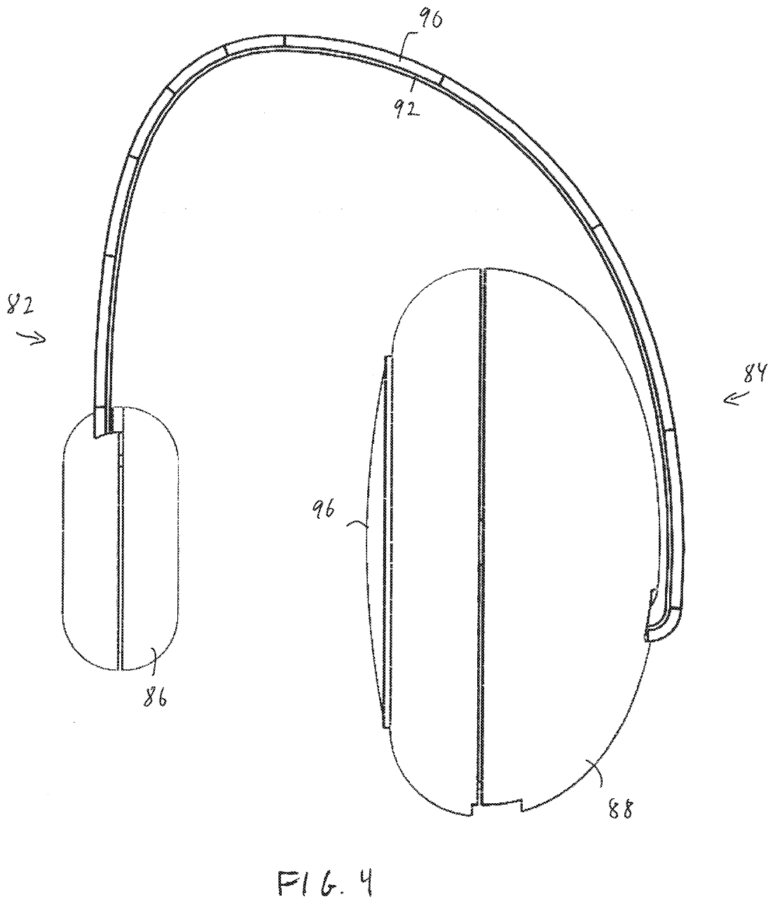

With reference to FIGS. 3 and 4, an illumination system 80 in accordance with an embodiment of the invention includes a front side 82 including an illumination dome 86, and a rear side 84 including a control dome 88. The illumination dome 86 is coupled to the control dome 88 via a band 90 that includes a circuit board 92 on the underside thereof. The illumination dome 86 includes an illumination source and an adjacent diffusing lens 94, and the control dome 88 includes a friction/adhesion pad 96.

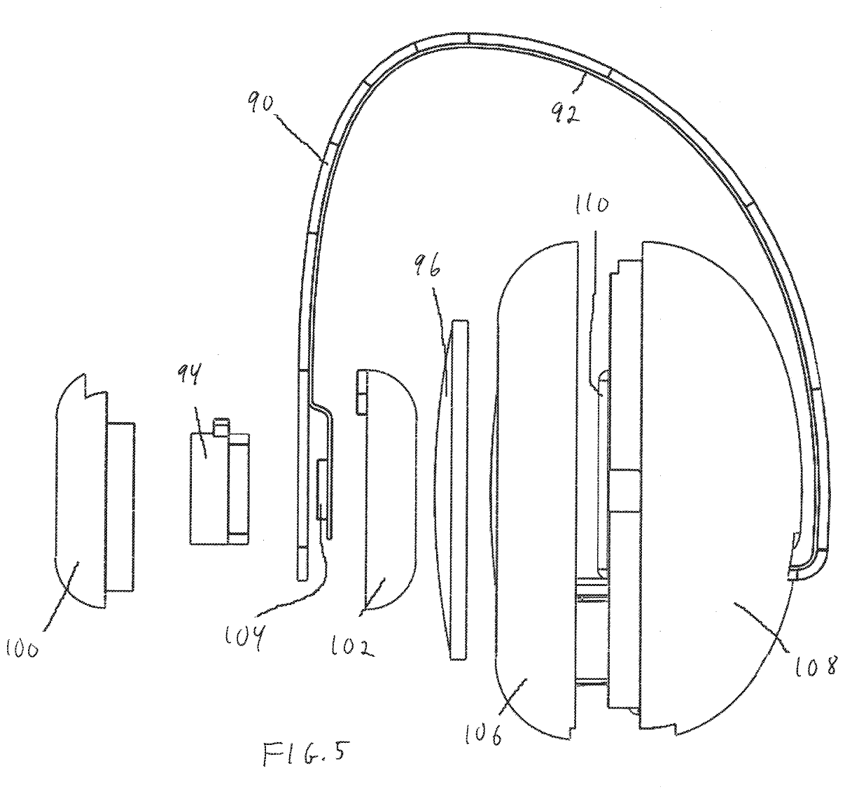

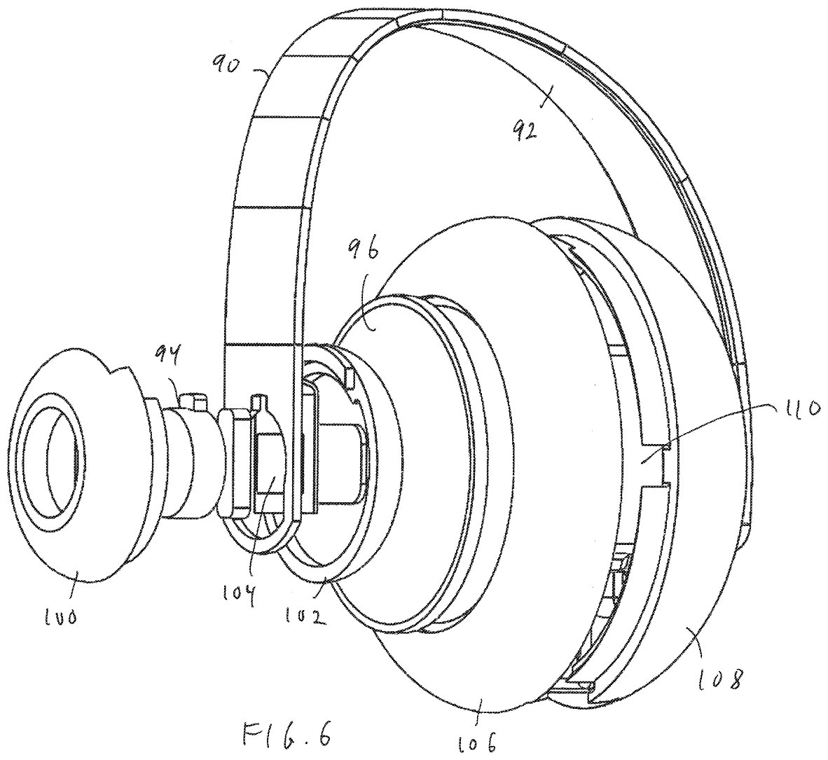

With further reference to FIGS. 5 and 6, the illumination dome includes an illumination dome enclosure top 100 and an illumination dome enclosure bottom 102 that contain the diffusing lens 94 as well as the illumination source 104. The control come includes a control dome enclosure top 106 and a control dome enclosure bottom 108 that contain the control electronics as well as the power source 110 such as a battery. The electronic systems is therefore partially or fully encapsulated by the enclosure as shown in the drawings. The enclosure can be any combination of materials (polymeric—rubber, plastic, moldable thermoplastics, etc. Composite—carbon fiber, metal, glass, wood, etc.). The enclosure can be any number of separate parts, shape, size, form, skin, cover, branding/logo, and configurations, and may interlock with one another and other components. The enclosure can take the shape of geometries like sphere, circular, triangular, square, pentagonal, rectangle, etc. or shapes resembling cartoon characters, animals, trees, plants, mushrooms, foods, drinks, faces, inanimate objects (cars, planes, etc.) in accordance with various aspects of the invention.

In accordance with various aspects, the enclosure may protect other components of the device from physical damage, water damage, gas damage, chemical damage, vibrational damage, temperature damage, shield components from electromagnetic interference EMI, etc. The enclosure may have internal features that secures electronic systems and all other components (including itself) by restricting some or all 6 degrees of movement (6 axis of movement, and may interlock with one another and other components by (for example) any combination of: friction, fasteners—screws, rivets, inserts, elastic bands, O-rings, etc., snap fits—interference fits, tabs, adhesives—glues, epoxies, tapes, welding—ultrasonic, thermal, and molding—over molding, insert molding etc. In an aspect, the system includes any number of parts of the plastic enclosure that are used to secure the battery, all ends of the electronic systems and all ends of the clip. There are ‘energy director’ or ‘channel’ designs into the mating surfaces of the top halves of each of the two sets of plastic enclosure to accommodate the use of ultrasonic welding or gluing with adhesives to fuse together the top and bottom sets of enclosure as well as securing all other components within them in accordance with an aspect of the invention.

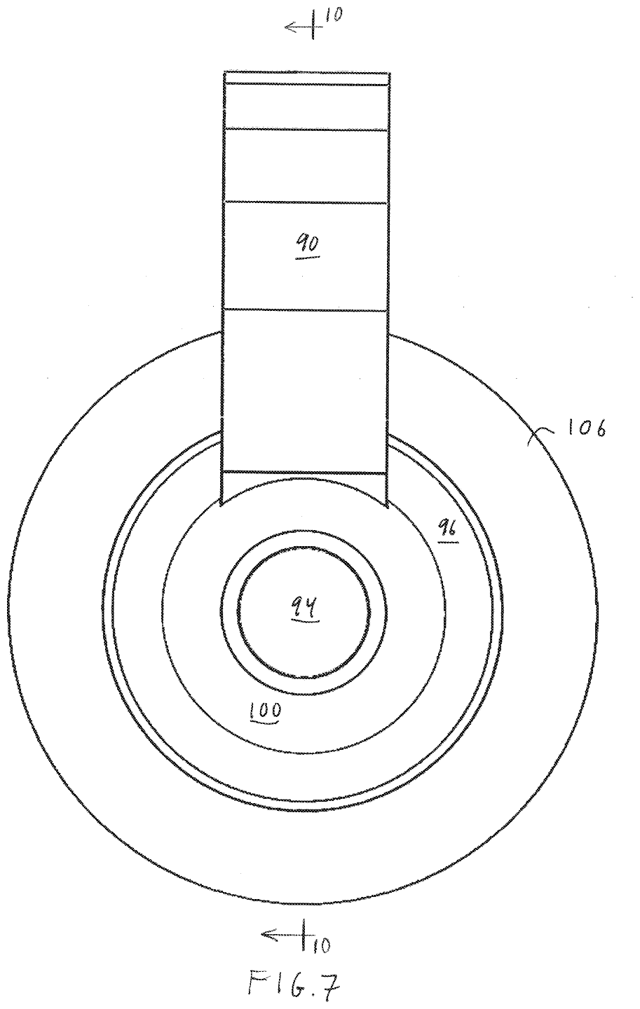

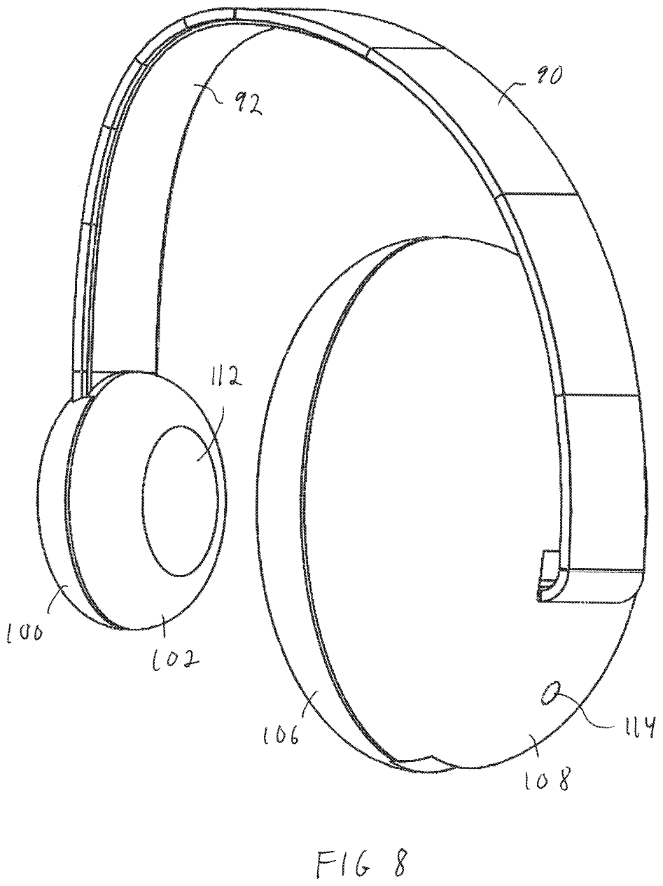

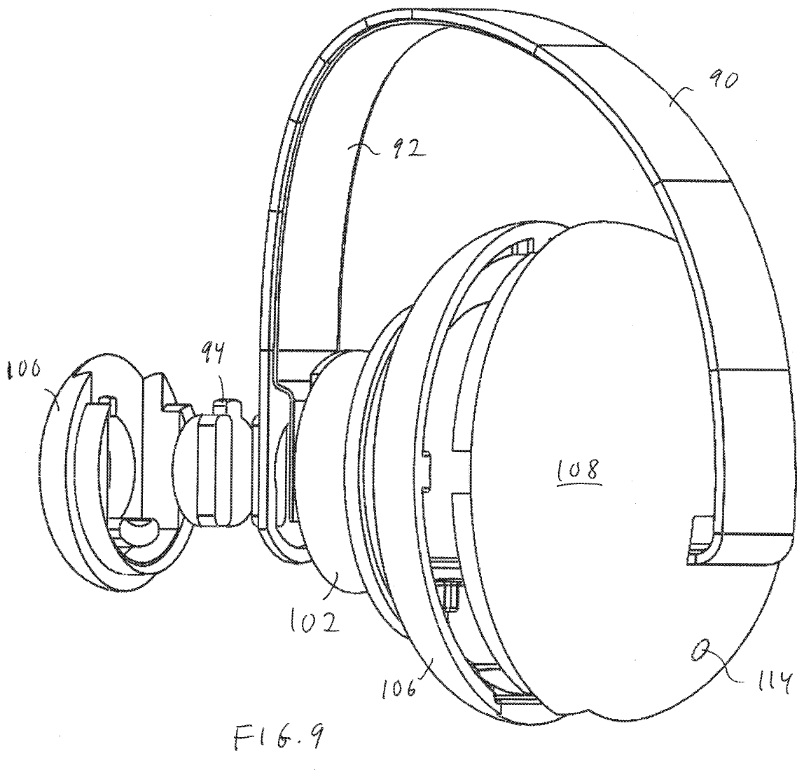

FIG. 7 shows a front view of the illumination system, showing the relative sizes of the dome enclosure top 100 and the control enclosure top 106, as well as the illumination diffusing lens 94 and the adhesion pad 96. FIGS. 8 and 9 show that the illumination dome may also include an optional adhesion pad 112, and that the control dome further includes a communication port 114 for use in accordance with certain aspects of the invention for communicating directly with, for example, a device. The attachment method for the enclosures enables/configures the enclosures to “detachably physically couple to” or “removably attached to” another surface or object. The attachment method can be the enclosure itself or any combination of the enclosure and other components. For example, a clip/clamp—may attach the enclosure to a surface or object via friction produced by the compression of a material under tension (such as a spring made of metal, a metal clip under tension, a spring pushing against other components to clamp onto a device, etc.) in accordance with an aspect of the invention. In accordance with further aspects, a removable adhesive may be used to attach the enclosure to a surface or object via adhesion produced by the inherent properties of variety of polymeric material (such as silicone, rubber, foam, pressure sensitive adhesive (PSA), etc.), epoxy, resin-type materials, Van der Waals forces, surface tension, suction cups, vacuum pressure. The fasteners may be of any number or variety of screws, nails, clips, Velcro, plastics, polymers, chemicals, epoxies, glues, adhesives, etc.

In accordance with certain aspects, the target object itself is magnetic or is attached with a separate piece of magnetic metal permanently or with very strong adhesive forces so the invention/device may magnetically attach to target object via embedded magnets or electromagnets. Attachment by way of any one or a combination of all of the four fundamental forces (gravity, weak nuclear, strong nuclear, and electromagnetic) and all of their forms (i.e., electromagnetic—covalent bonds, metallic bonds, ionic bonds, ion-dipole bonds, dipole-dipole bonds, hydrogen bonds, rotating dipole-dipole bonds, dipole-induced dipole bonds, induced dipole-induced dipole bonds, etc.).

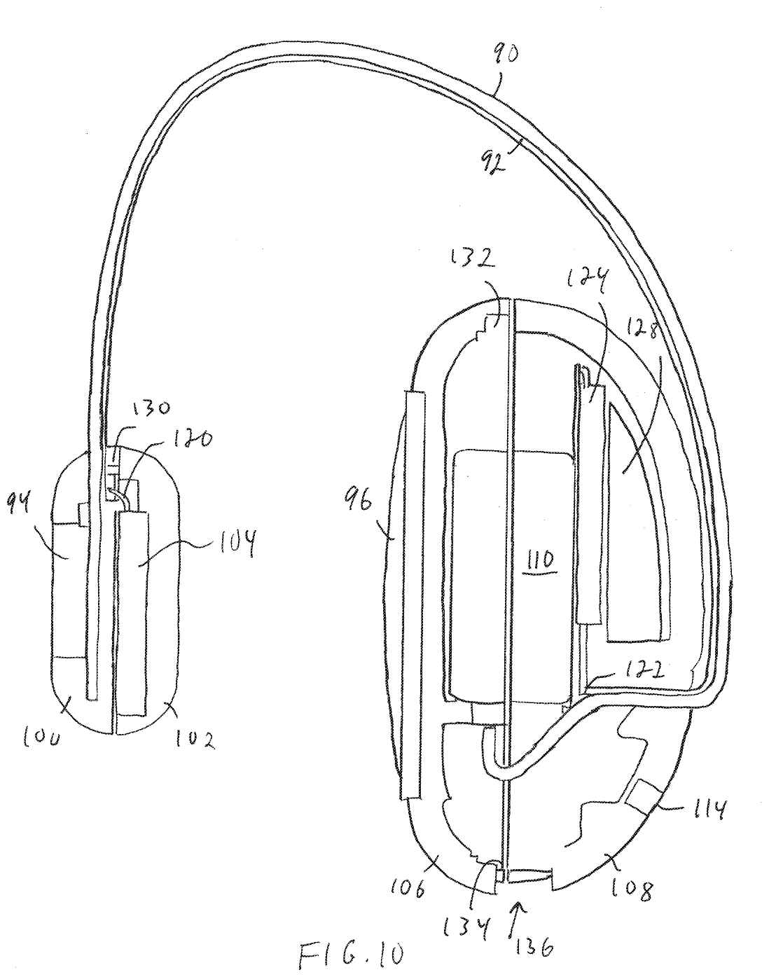

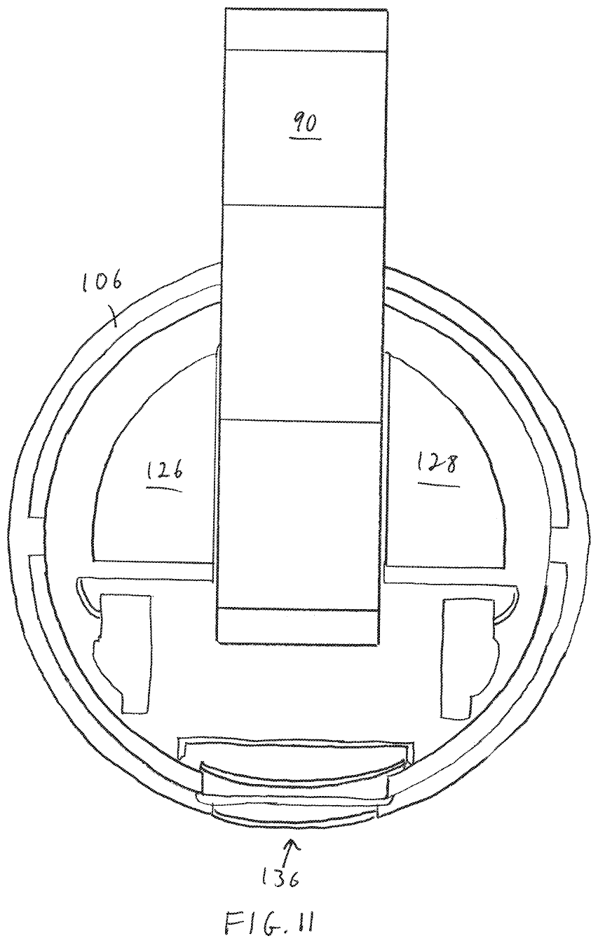

With reference to FIGS. 10 and 11, the system may further include wiring 120 coupling the circuit board 92 to the illumination source 104, as well as wiring 122 coupling the circuit board 92 to a controller 124. FIG. 11 shows the system with the dome enclosure 108 removed. The controller 124 is coupled to two detection units 126, 128 and provides the operational functionality discussed above with reference to FIGS. 1 and 2. The dome attachment mechanisms are shown at 130, 132, 134, and a charging/communications port is provided at 136.

In accordance with further aspects, illumination systems may be removably attached physically and/or communicate with wired/wirelessly with other electronic and/or computing devices such as smartphones (iPhone, android, Samsung galaxy, Huawei), tablets (iPad, android), computers (desktops, laptops, Chromebooks), personal digital assistants (PDAs), mobile phones, satellite phones, cellular phones, pagers, music players (iPod, zune), MP3 players, media players, digital cameras, video cameras, bar code scanners, global positioning systems (GPS), gaming console systems (Nintendo ds, 3Ds, Switch, Playstation portable, PSP, Gameboy, Playstation, Xbox), smart devices (iot devices, google home, amazon echo/dot, smart refrigerator, smart oven, smart television, smart mirror, smart wall, smart table, smart chair, smart bed, smart lights/lamps, smart cabinets, smart shelves, smart security camera, smart door lock, etc.), etc. The systems may be removably attached physically to any things such as books, tables, walls, bags, wallets, shelves, clothing, hats, shoes, pants, jacket/coats, doors, tripods, cases, chairs, ceiling, pens/pencils, car, bicycles, cups, floor, tree, animals, plants, etc.

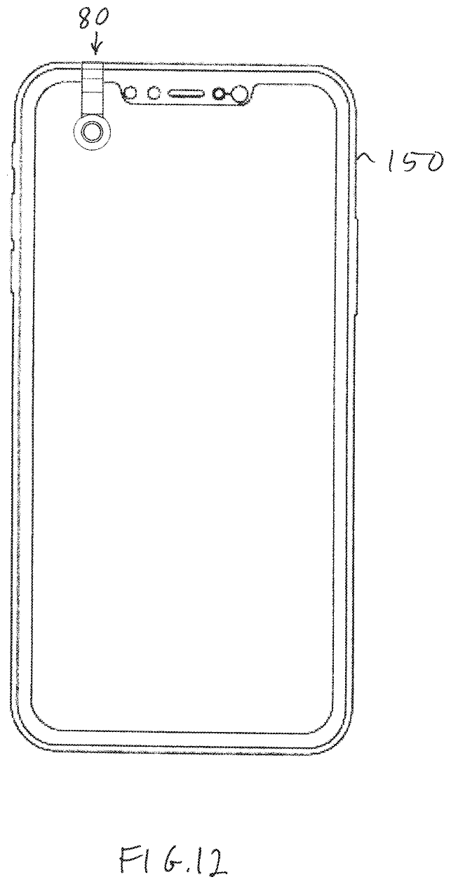

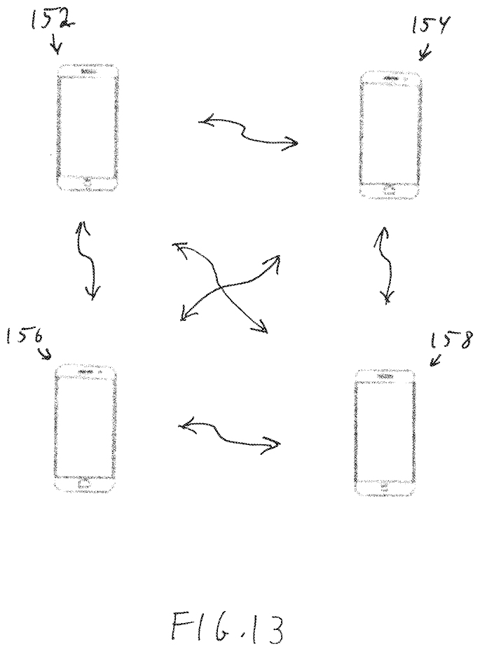

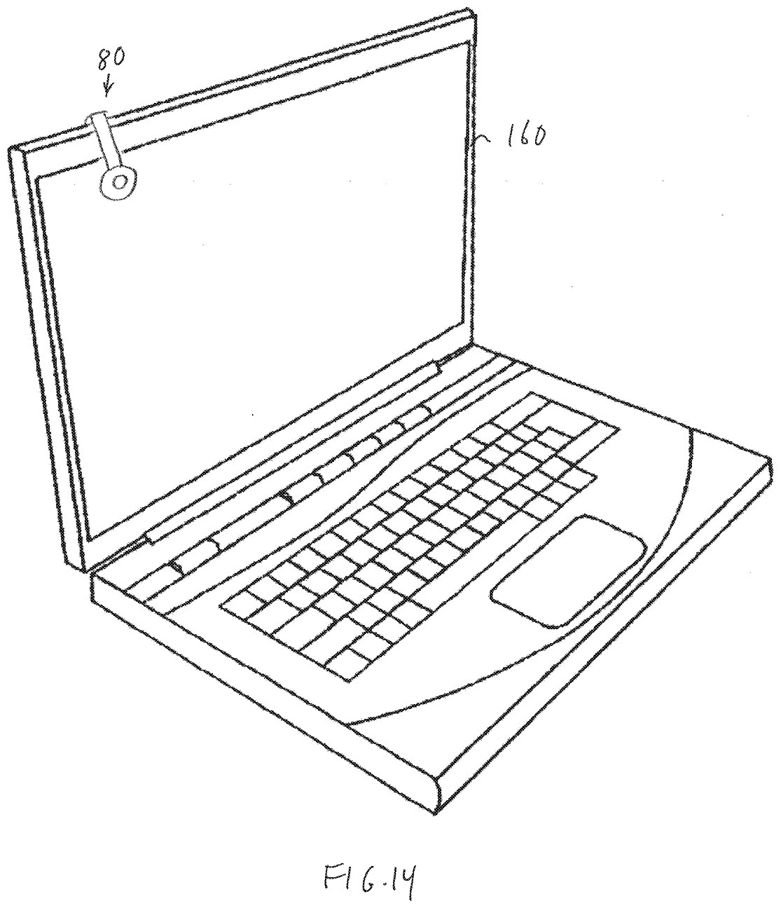

FIG. 12, for example, shows an illumination system 80 attached to a smart phone 150 in accordance with an aspect of the invention. FIG. 13 shows that multiple smart phones 152, 154, 156, 158 (each including a system 80) may be in communication with each other as discussed above. FIG. 14 shows a system 80 attached to a laptop 160 in accordance with a further aspect of the invention.

The illumination system may include a single metal clip shaped in such a way as to enable the enclosure attached to the ends of the clip to impart frictional forces upon any object that is wedged between it. The device also has an adhesive pad attached to the underside the enclosure providing additional frictional forces upon any object's surface that comes into contact with the pad. The metal clip is also designed in such a way as to dynamically flex elastically to accommodate different sizes and shapes of objects to be attached/clipped to it as well as to enable the user to plastically deform the metal clip to accommodate custom fitment/attachment preferences.

The assembly may be made from parts including, one pcb board with all electronic systems, and one enclosure which doubles as an attachment. A minimal design can be achieved when the pcb board is overmolded/insert molded with a variety of polymeric material (rubber, plastic, silicone, etc.) into any shape such as a cylinder, which acts as the enclosure as well as having adhesive properties, enabling attachment to any surface via adhesion. The system in accordance with an aspect includes one FPCB board with all electronic systems, four plastic enclosure/housing, one metal clip as attachment method, one lens for light diffusion, one adhesive friction pad for attachment assistance in accordance with an aspects of the invention.

The process of providing an illumination system may involve embedding the electronic systems into FPCB flexible printed circuit board, is partially adhered via PSA adhesive along the underside of the metal clip. The front of this clip and board subassembly is then inserted through a slot on the top back enclosure and pulled through its length until the back of this clip is secured via friction. The back of the board is then folded in such a manner as to fit into the cavity of the top back enclosure. The bottom back enclosure is then aligned with the top back enclosure via alignment features and then both halves of the back enclosure are fused together via an Ultrasonic Welding machine. (or over molding machine). The front of the clip and board subassembly is inserted into a slot on the top front enclosure and secured in place via friction. The lens is inserted through the front of the clip and the top front enclosure securing itself via friction. The bottom front enclosure is then aligned with the top front enclosure via alignment features and then both halves of the front enclosure are fused together via an Ultrasonic Welding machine, or gluing machine, or over-molding machine. The Pad is adhered onto the bottom side of the bottom back enclosure.

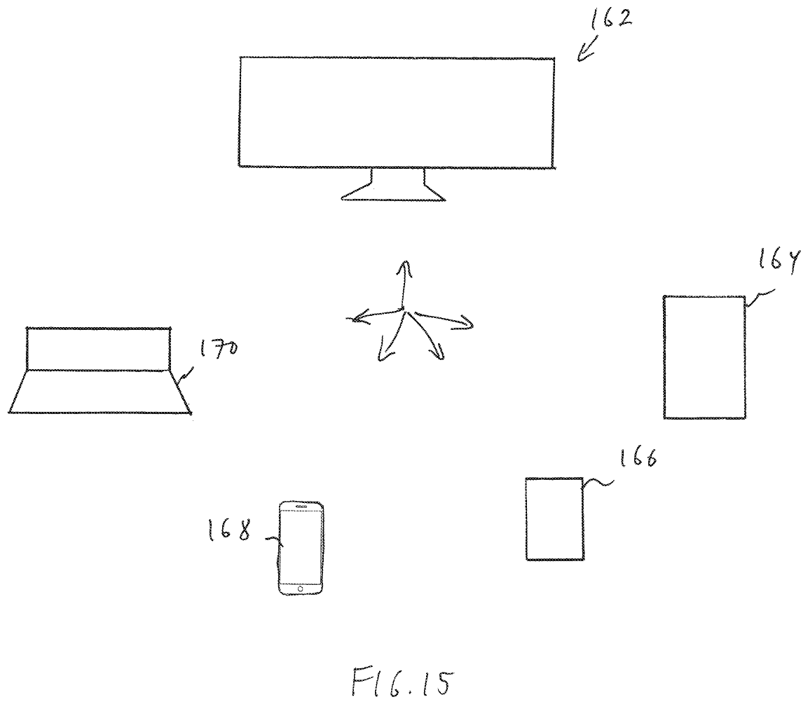

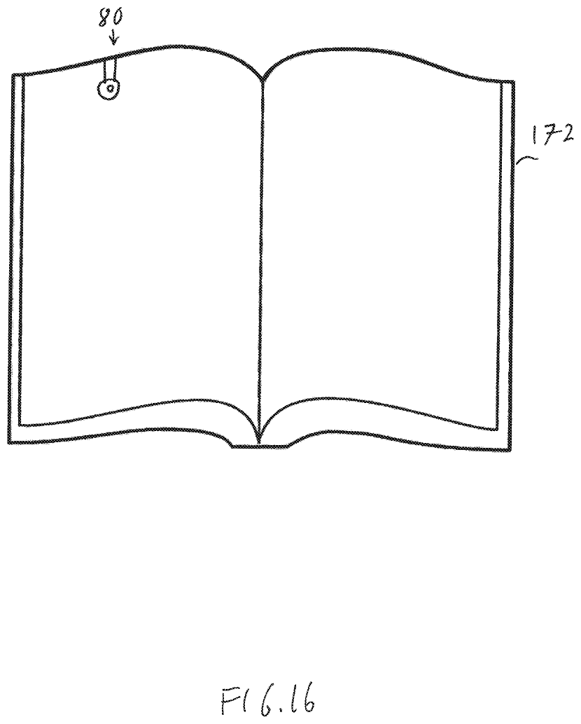

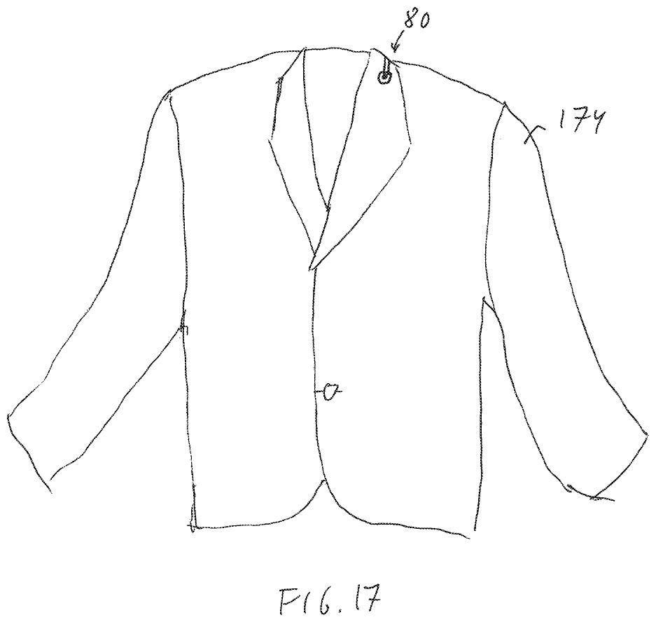

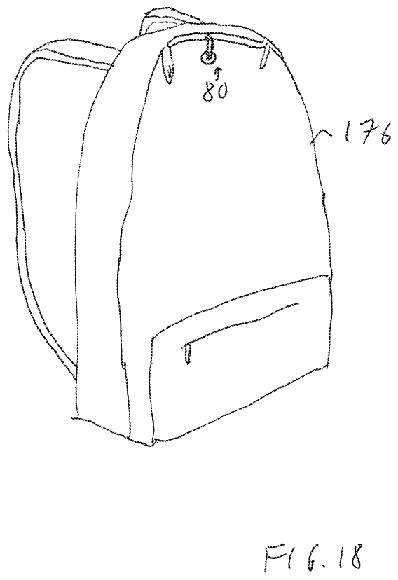

In accordance with further aspects, systems of aspects of the invention may further be used with smart monitors 162, tablets 164, iPads 166, smart phones 168 and laptops 170, each of which may be in communication with the other devices as shown in FIG. 15. In accordance with further aspects, illumination systems 80 may be attached to any of a book of printed media 176 (shown in FIG. 16), a garment or wearing apparel 178 (shown in FIG. 17), or a bag, handbag or other carrying container 180 (shown in FIG. 18).

In accordance with various aspects therefore, the illumination system provides: a standalone device itself—a light outputting device, a device that is configured to attach to a smartphone/mobile device/computing device/device with camera, a device that is configured to attach to anything, normal objects, walls, electrical devices, computing devices, clothing, etc., a lighting device (Selfie, lamp, studio lighting, flash, LED, accessory, auxiliary, article, apparatus), a system for illuminating people or things, a system that communicate with other devices (other units of the invention, mobile devices, etc.) for illuminating people or things, and a device to be used with other units of itself, master and slave, a node in a network, swarm effect, can be user controlled or self-directed by AI/machine learning, spontaneous.

Those skilled in the art will appreciate that numerous modifications and variations may be made to the above disclosed embodiments without departing from the spirit and scope of the present invention.

What is claimed is:

1. A system for providing illumination, said system comprising at least one sensor that is not visible from outside the device, said sensor for controlling at least an aspect of the illumination.

2. The system as claimed in claim 1, wherein the at least one sensor is an inductive sensor.

3. The system as claimed in claim 1, wherein the at least one sensor is a capacitive sensor.

4. The system as claimed in claim 1, wherein the at least one sensor is a proximity sensor.

5. The system as claimed in claim 1, wherein the at least one sensor is an ultrasonic sensor.

6. A system for providing illumination of a subject from a front side of the system, said system including a back side and at least one sensor proximate the back side for controlling the illumination from the front side.

7. The system as claimed in claim 6, wherein the back side is dome shaped.

8. The system as claimed in claim 6, wherein the at least one sensor is an inductive sensor.

9. The system as claimed in claim 6, wherein the at least one sensor is a capacitive sensor.

10. The system as claimed in claim 6, wherein the at least one sensor is a photoelectric sensor.

11. The system as claimed in claim 6, wherein the at least one sensor is an ultrasonic sensor.

12. The system as claimed in claim 7, wherein the front side is dome shaped.

13. The system as claimed in claim 6, wherein the at least one sensor is not visible from the back side.

14. The system as claimed in claim 6, wherein the at least one sensor is visible from the back side.

15. The system as claimed in claim 6, wherein the illumination is entirely controlled by the at least one sensor.

16. A system for illuminating a subject, said system comprising:
a portable computing device including any of a smartphone, a tablet, a smartwatch or a laptop; and
an illumination device that is removably attached to the computing device.

17. A system for illuminating a subject, said system comprising:
a personal non-computing object including any of an article of apparel, a clothing, a personal bag or an accessory; and
an illumination device that is suitable for use with the personal non-computing object.

18. A system for providing illumination, said system comprising at least two portions separated by a flexible band, one portion including at least one illumination unit and the other portion including at least one control unit, wherein the flexible band includes electronic circuitry coupled to both the illumination unit and the control unit.

19. The system as claimed in claim 18, wherein the flexible band includes a circuit board.
